(19) United States
(12) Patent Application Publication
(10) Pub. No.: US 2017/0254485 A1
(43) Pub. Date: Sep. 7, 2017

(54) STRAIGHT TUBE TYPE LIGHT EMITTING DIODE LAMP

(71) Applicant: Abram Corporation, tokyo (JP)

(72) Inventor: Hidetoshi MITSUZUKA, Tokyo (JP)

(21) Appl. No.: 15/519,825

(22) PCT Filed: Jun. 5, 2015
(86) PCT No.: PCT/JP2015/066371

§ 371 Date: Apr. 17, 2017

(30) Foreign Application Priority Data
Oct. 17, 2014 (JP) 2014-212768

(51) Int. Cl. F21K 9/275; F21V 7/22; F21V 29/70; F21V 3/02; F21K 9/272

(52) U.S. Cl. CPC F21K 9/275; F21V 3/02; F21K 9/272; F21V 29/70; F21V 7/22; F21Y 2115/10

(57) ABSTRACT

The present invention provides a straight tube type light emitting diode lamp with which high heat dissipation performance and high illuminance can be obtained. A cover (23) has a translucent cover (31) through which light emitted from an LED element (13) passes, and a first heat sink (33) coupled to a heat sink (15). A second heat sink (17) receives heat via a substrate (12), said heat having been generated from the LED element (13), and transmits the heat to a third heat sink (19). The third heat sink (19) extends toward the translucent cover (31) from one end, which serves as a coupling section coupled with the second heat sink (17), and the other end is coupled to the first heat sink (33). The LED element (13) is positioned on a center line (61) of the translucent cover (31) formed along a cross-section thereof.

### TECHNICAL FIELD

The present invention relates to a straight tube type light emitting diode lamp characterized by a structure of heat dissipation and reflection.

### BACKGROUND ART

The principle of light emission of an LED is glowed when a voltage is applied to a semiconductor element. When the semiconductor element is mounted on the substrate, and electricity passes through the LED element, heat is generated at that time.

In order to dissipate the generated heat, it is necessary to provide a heat sink.

Compared with conventional incandescent lamps and LED, the LEDs reduces the power consumption, and a illuminance and light energy of the same degree are obtained. It is expected that LED will become more popular in the future. The LED illumination lamp has the same appearance as the fluorescent lamp and can be installed in place of the existing fluorescent lamp. LED lighting is a typical LED light source.

LED lighting is divided into lighting and plant cultivation. The illumination lamp comprises a cylindrical tube. The tube has a light emitting surface made of translucent or transparent glass or synthetic resin and a heat sink for radiating the heat of the LED substrate. The tube has a circuit board on one side for mounting LED elements at predetermined intervals. The LED lamp has the same shape as the fluorescent lamp. The illumination lamp has terminals for attaching a cap to both ends and connecting to the appliance. The LED illumination lamp can be attached to an existing fluorescent lamp device. LED lights are powered from power.

An LED illumination lamp is described in Patent Document 1 (Japanese Patent Application Laid-Open No. 2011-113876). Here, the LED illumination lamp includes a cylindrical tube made of polycarbonate, an aluminum heat sink mounted in an opening provided in a part of the periphery of the tube, and a plurality of LEDs mounted in the tube.

In Patent Document 2 (Japanese Patent Application Laid-Open No. 2013-219004) the LED illumination lamp is disclosed a ring-shaped structure, the structure comprises a cavity inside by a semitransparent casing, and a heat radiation plate having a holding portion coupled to the casing, and a circuit board to be fixed to the holding portion, one or more LED light sources mounted on the a circuit board and an end cap fitted to both ends of the annular structure.

### DISCLOSURE OF THE INVENTION

In the LED lamps of Patent Documents 1 and 2, heat dissipation of heat generated when the LED emits light is not sufficient. Conventional LED lamps have problems with heat dissipating material and design.

For heat conduction, it is preferable to use iron for the heat sink material, but since the iron has a high specific gravity, the weight of the LED illumination lamp exceeds the weight limit: 500 grams. Aluminum is used for the heat sink material because the weight of the LED lamp exceeds 500 grams. However, the thermal conductivity of aluminum is about 3 times that of iron. For this reason, it is difficult to prolong the life of the LED because heat dissipation of the LED is not sufficient. Also, you need to touch carefully while a person is lit.

The numerical value of the brightness of the LED lamp is expressed in lumens (lm). The lumen collectively represents the total amount (total luminous flux) of light radially irradiated in all directions. Therefore, tine brightness just under the light source and its surroundings may actually become dark without actually obtain the numerical value of the lumen.

Therefore, although the LED illumination lamp is suitable for a wide range of illumination, it is not suitable for cases where the amount of light is required right under the light source or its vicinity (180 to 90 degrees).

The present invention has been made in view of the above problems, and an object thereof is to provide a straight tube type light emitting diode lamp capable of obtaining high heat radiation property and illuminance.

The A straight tube type light emitting diode lamp comprises
a light emitting diode,
a translucent cover which transmits light from the light emitting diode and has a curved surface protruding in a direction away from the light emitting diode,
a first heat sink formed on the light emitting diode side with respect to the translucent cover so as to accommodate the light emitting diode in a closed space integrally formed with the translucent cover,
a heat conducting substrate provided in the closed space and mounted with the light emitting diode,
a second heat sink provided in the closed space and supporting the substrate,
a third heat sink has a first surface having a light reflecting characteristic on the light emitting diode side so as to direct the light from the light emitting diode to the translucent cover and transmits heat from the second heat sink to the first heat sink in the closed space,
a third heat sink provided a first surface extending from the second heat sink toward the translucent cover, and
a second heat sink member which is provided at opposite the translucent cover with a gap between the curved surface of the translucent cover, and extends from the vicinity of an end portion on the side opposite second heat sink of the first heat sink member to couple the first heat sink,
wherein the light reflected at the inner surface of the translucent cover in the light from the light emitting diodes is reflected on the second surface having the light reflection characteristic opposite the translucent cover of the second heat sink member and the reflected light is passed through the translucent cover.

The end portion of the first heat sink member of the straight tube type light emitting diode lamp is positioned on the translucent cover side with respect to the first heat sink.

In the sectional view of the cylindrical closed space, the light emitting diode of the straight tube type light emitting diode lamp is located on the center line of the translucent cover along the cross section. The third heat sink is line symmetrical with respect to the center line.

The present invention has been made in view of the above problems, and an object thereof is to provide a straight tube type light emitting diode lamp capable of obtaining high heat radiation property and illuminance.

### BRIEF DESCRIPTION OF THE DRAWINGS

FIG. 1 is a perspective view of a straight tube type light emitting diode lamp according to an embodiment of the present invention.

FIG. 2 is an exploded perspective view of the straight tube type light emitting diode lamp shown in FIG. 1.

FIG. 3 is a cross-sectional view of the straight tube type light emitting diode lamp taken along the section line A-A shown in FIG. 1.

FIG. 4 is a view for explaining the heat sink structure of the A straight tube type light emitting diode lamp

FIG. 5 is a view for explaining a heat sink structure of a conventional a straight tube type light emitting diode lamp.

FIG. 6 is a diagram for explaining the effect of the straight tube type light emitting diode lamp

FIG. 7 is a diagram for explaining the effect of the straight tube type light emitting diode lamp

FIG. 8 is a diagram for explaining another example of the straight tube type light emitting diode lamp

### BEST MODE FOR CARRYING OUT THE INVENTION

In the A straight tube type fight emitting diode lamp according to the present invention, the distance between the heat sink part directly under the substrate on which the LED element is mounted and the heat sink part touched by the human body has a length of two to three times as long as the conventional heat sink.

This improves the thermal conduction efficiency and enhances the heat dissipation effect of the heat generated when the LED element is energized.

Heat sink structure beneath the substrate on which the LED element is mounted is semicircular and the distance between the element directly under the LED element and the heat sink that touches the human body is not a short structure. In order to lengthen the distance from directly under the LED element to the heat sink which touches the human body, an M type structure is adopted, thus enhancing heat conduction efficiency and promoting heat dissipation.

The structure adopts an M-shaped heat sink structure that collects light at a fixed angle and reflects the collected light. With this structure, the light emitted from the LED element is reflected and directed in a predetermined direction. Therefore, the illuminance can be improved.

For heat sink of M type structure, heat sink surface on LED element side is subjected to silver painting, plating or chromium treatment with high reflection efficiency in order to make the light distribution angle wide. Likewise, in order to make the light distribution angle wide, the heat sink cover adopts a diffusion type or a prism type.

An embodiment of the present invention ewill be described with reference to the accompanying drawings.

The A straight tube type light emitting diode lamp is characterized by a heat sink, a heat sink cover attached thereto, and a mounting structure.

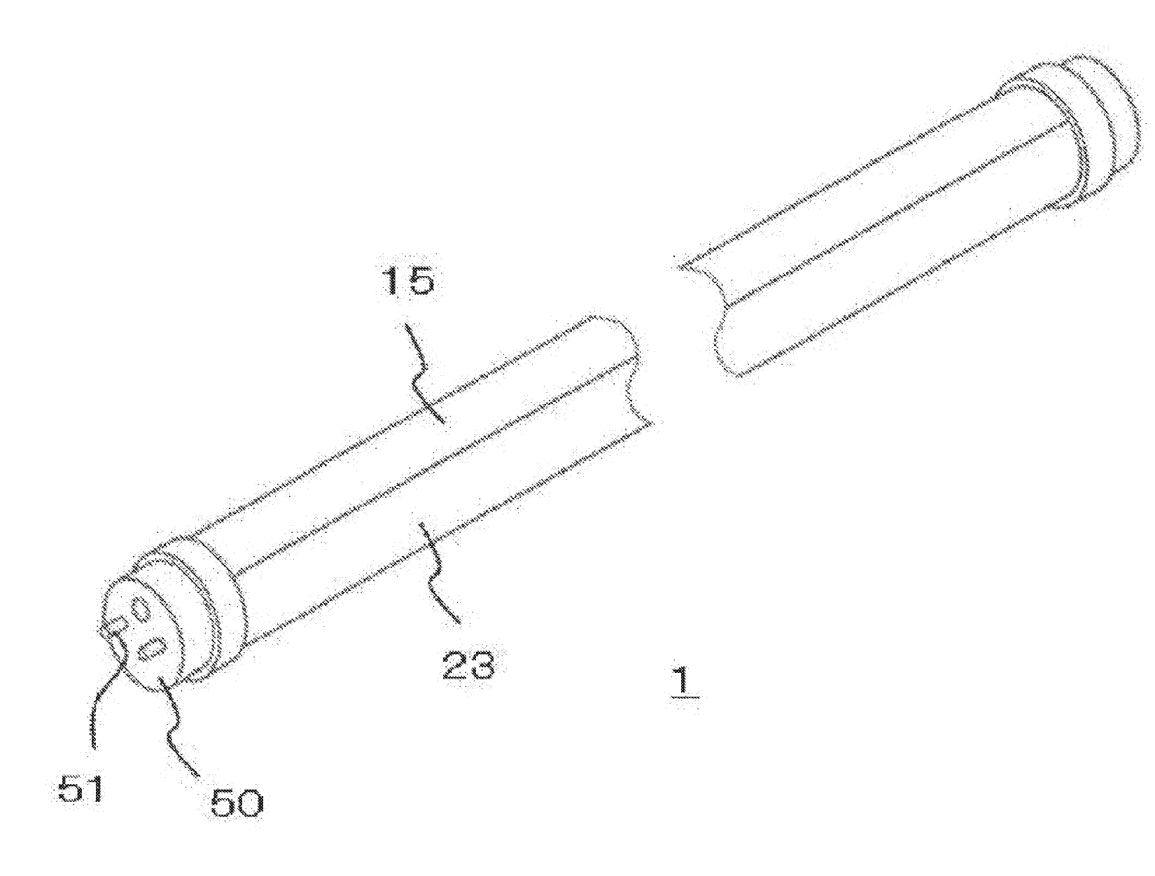

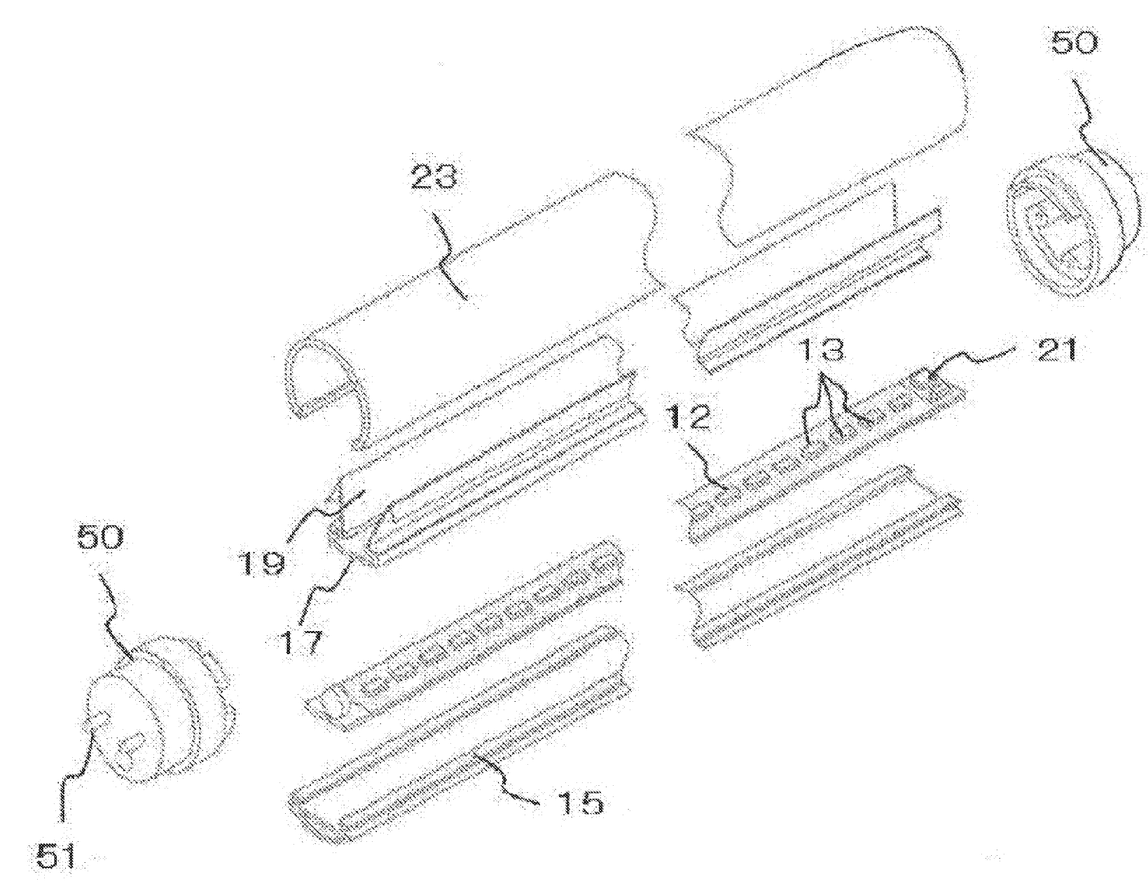

FIG. 1 is a perspective view of a A straight tube type light emitting diode lamp according to an embodiment of the invention.

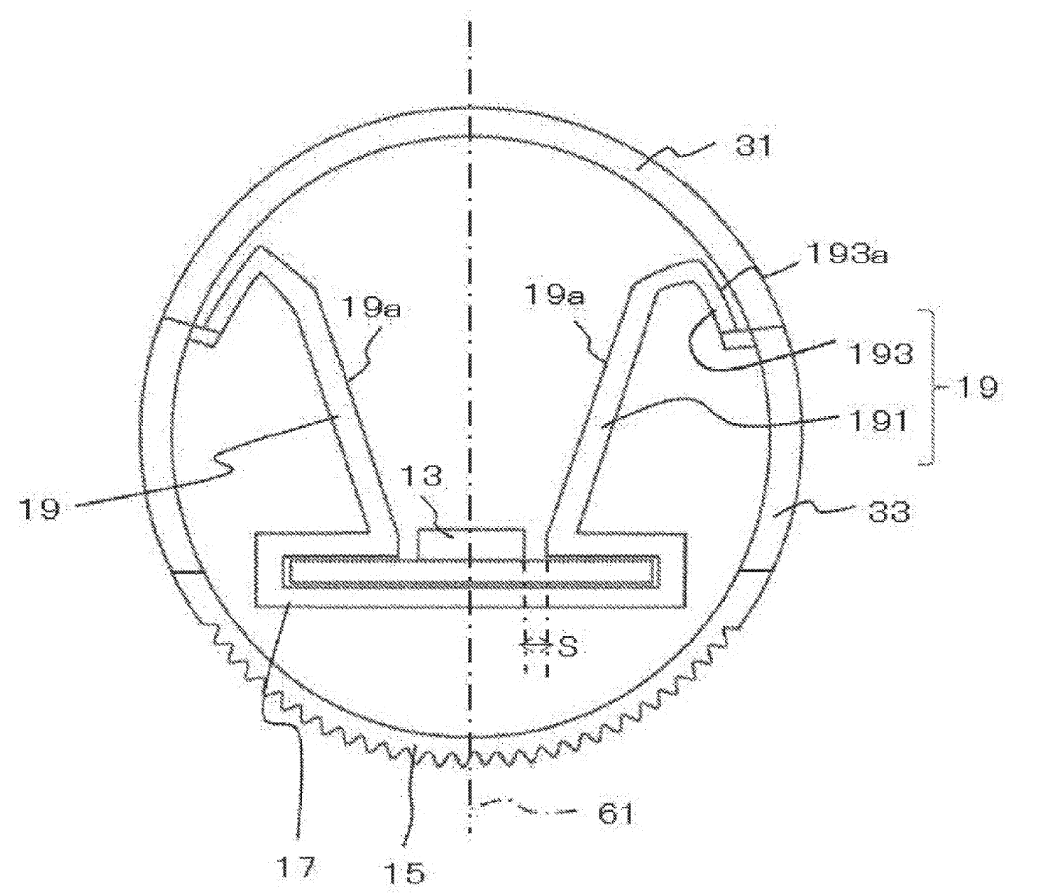

FIG. 2 is an exploded perspective view of the A straight tube type light emitting diode lamp

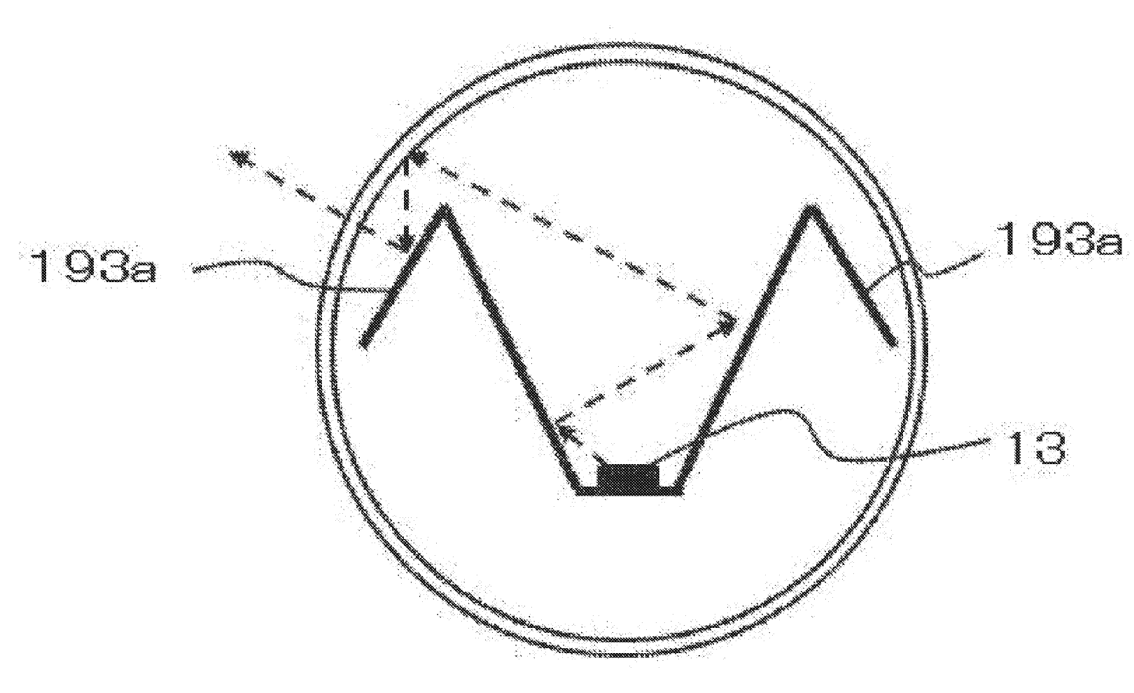

FIG. 3 is a cross-sectional view of the A straight tube type light emitting diode lamp taken along the section line A-A shown in FIG. 1.

The straight tube type light emitting diode lamp has a length and a diameter which replace the fittings of conventional lamps. The total length of the illumination lamp is the same as that of the conventional illumination lamp. The length can be appropriately set to 300 mm, 450 mm, 600 mm, 900 mm, 1200 mm, 800 mm, 2400 mm or the like depending on the application.

The diameter of the tube of the illuminating lamp is almost the same as that of the conventional fluorescent lamp. The illumination lamp has substantially the same external appearance and appearance as the conventional illumination lamp.

In FIG. 1 to FIG. 3, the straight tube type light emitting diode lamp comprises an LED element 13, a substrate 12 for implementing the LED element, a heat sink 15, a second heat sink 17, a third heat sink 19, an LED controller, a cover 23, and an end cap 50. The second heat sink 17 and the third heat sink 19 are integrally molded.

As shown in FIG. 3, the cover 23 includes a translucent cover 31 for transmitting light from the LED element 13 and a first heat sink 33 coupled with the heat sink 15.

The connection of the heat sink means that the two heat sinks are integrally molded, or they are in contact with each other so that heat is transmitted to the two heat sinks.

A closed space is formed by the heat sink 15, the cover 23 and the end cap 50. The closed space accommodates the LED element 13, the substrate 12, the second heat sink 17, the third heat sink, and the like.

The end cap 50 is fitted to the end of the tubular structure constituted by the heat sink 15 and the cover 23. The end cap 50 is provided with power supply pins.

As shown in FIG. 2, a plurality of LED elements 13 are arranged on the substrate 12 at equal intervals along the longitudinal direction. An LED controller 21 is arranged at the end of the substrate 12.

As shown in FIG. 3, the substrate 12 is accommodated and supported in the longitudinal internal space (closed space) of the second heat sink 17.

The LED element 13 is disposed so that its light emitting surface faces the translucent cover 31 at the opening on the strike formed on the side of the translucent cover 31 of the second heat sink 17.

The substrate has thermal conductivity. The second heat sink 17 transmits the heat generated from the LED element 13 to the third heat sink 19 via the substrate 12.

The third heat sink 19 extends from one end of the coupling portion with the second heat sink 17 toward the translucent cover 31 and the other end is connected to the first heat sink 33.

As shown in FIG. 3, in the cross section of the closed space of the A straight tube type light emitting diode lamp 1, the LED element 13 is arranged on the center line 61 of the translucent cover 31 along the cross section.

As shown in FIG. 3, the substrate 12, the LED element 13, the second heat, sink 17, the third heat sink 19, the translucent cover 31, and the first heat sink 33 are disposed in line symmetry with respect to the center line 61.

The surface 19a on the LED element 13 side of the third heat sink 19 has light reflection characteristics. The total reflectance of the surface 19a of the third heat sink 19 is set to 80% or more in order to improve the light emission illuminance of the LED element 13 to be equal to or higher than that of the conventional fluorescent tube. Specifically, for example, silver plating, silver coating, chromium treatment and the like are performed on the surface 19a

The illuminance at this time is based on the “light brightness theorem” that the brightness is inversely proportional to the square of the distance between the light source and the irradiated surface”, the length S of the distance between the LED element 13 and the third heat sink 19 is set to 1 to 1.5 mmT.

The third heat sink 19 is disposed in a posture in which light from the LED element 13 is directed to the translucent cover 31.

The third heat sink 19 forms an angle α with the surface of the substrate 12. The angle α is, for example, 30 to 70 degrees.

The third heat sink 19 includes a first heat sink member 191 extending from the second heat sink 17 toward the translucent cover and a second heat sink member 193.

The second heat sink member 193 is coupled to the first heat sink 33 extending from the vicinity of the end opposite to the second heat sink 17 of a first heat sink member 191 so as to face the translucent cover. The surface 193a of the second heat sink member 193 facing the translucent cover 31 has light reflection characteristics.

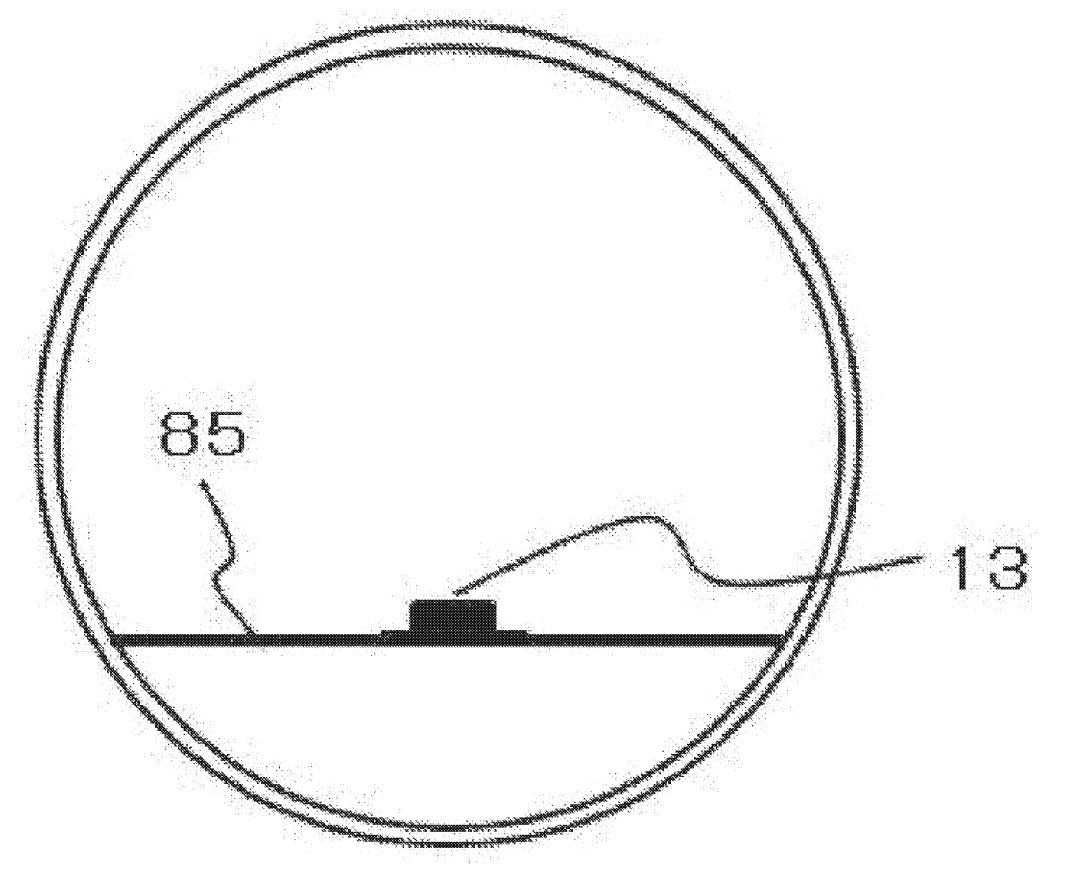

The surface 193a of the second heat sink member 193 has light reflection characteristics. As a result, in the light from the LED element 13, as shown in FIG. 4, the light reflected on the inner surface of the translucent cover 31 is reflected by the surface 193a and can passes through the translucent cover 31.

By subjecting the surface 193a to a treatment for increasing the reflection efficiency (silver coating or the like), the surface 193a has enhanced radiation efficiency and reflection efficiency.

The treatment for enhancing the reflection efficiency is silver coating, silver plating and the like. Silver paint an improve total reflectance by 90%. Further, matching between the reflecting material and the heat sink is unnecessary, and the quality is improved.

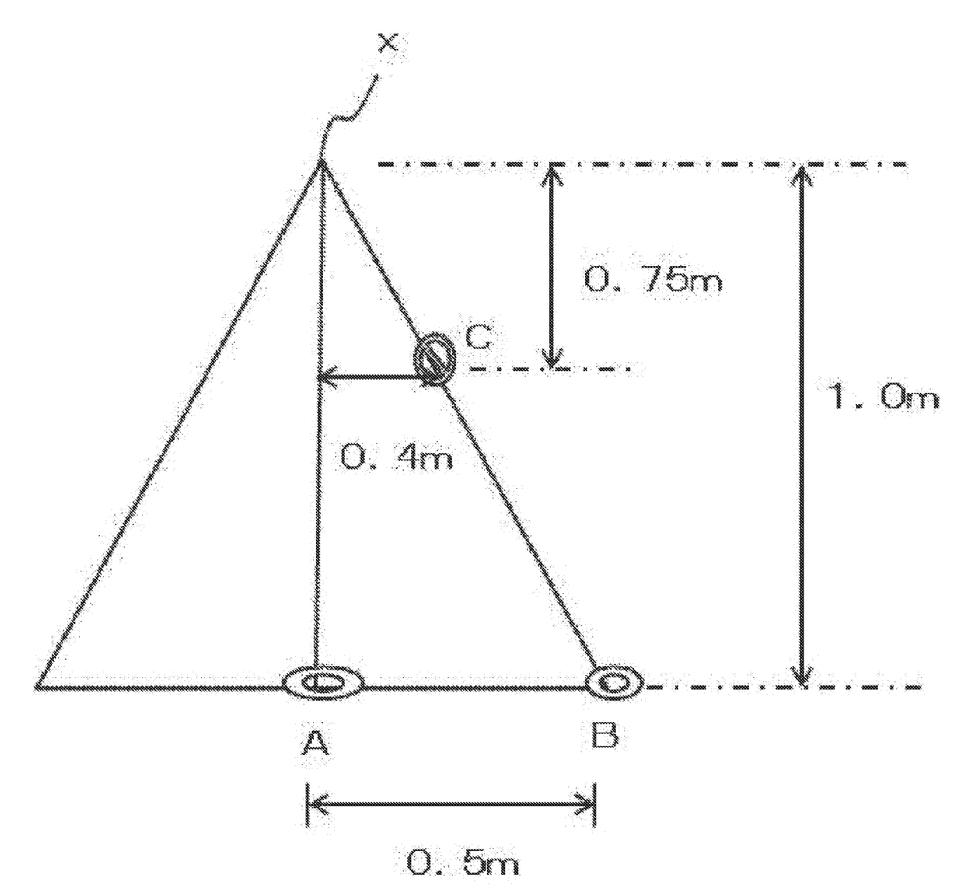

As described above, by using the third heat sink 19 having the shape shown in FIGS. 2 and 3, the distance between the LED element 13 and the outer peripheral surface (the portion touched by the human body) of the illumination lamp 1 can be lengthened (more than twice) such as the conventional structure shown in FIG. 15. In FIG. 5, reference numeral 85 is a heat sink. This heat sink 85 provides a high heat dissipation effect. When aluminum is used the heat sink, the heat of the part touched by the human body can obtained a safe temperature (for example, 40° C.).

The heat sink material can use copper or aluminum which is excellent in heat conduction efficiency

The illuminance of the structure shown in FIG. 3 is higher than the illuminance of the conventional structure shown in FIG. 5. As described with reference to FIG. 4, since the surface 193a of the second heat sink member 193 has the light reflection characteristic, the illumination distribution can be set at a wide angle (140 degrees or more). As a result, the illumination lamp can realize the performance (illuminance and light distribution) of the conventional fluorescent lamp with 50% power consumption, so energy saving can be achieved. Also, since the illumination lamp does not generate high heat in a fluorescent tube, the illumination lamp obtains high safety.

The second heat sink 7 and the third heat sink 19 can be drawn out using a mold alumite material. For this reason, the processing is simplified, so that cost reduction and shortening process can be obtained.

The straight tube type light emitting diode lamp can make the surface temperature of the heat sink safe even when touched by the human body (about 40° C.), which is the biggest problem of the LED, and the illuminance should be equal to or higher than that of the fluorescent lamp.

The illumination lamp can set the illuminance distribution to a wide angle (140 degrees or more). The illumination lamp enables performance (illuminance and light distribution) of the conventional fluorescent lamp with 50% power consumption of the fluorescent lamp.

The illumination lamp obtains an energy saving illumination light source. The power consumption can decrease from ½ to ⅓ compared to fluorescent lights, the illuminance and PFFD can be increased from 2 to 3 times. The illumination lamp does not generate high heat such as a fluorescent lamp and contributes to safety and security. The weight of the lighting lamp can be 500 g or less.

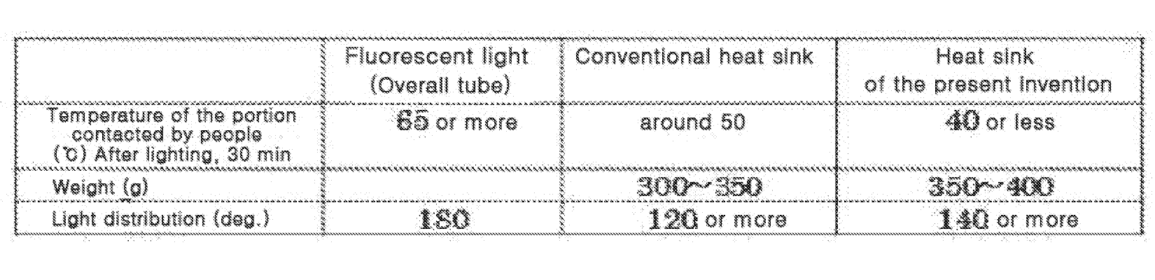

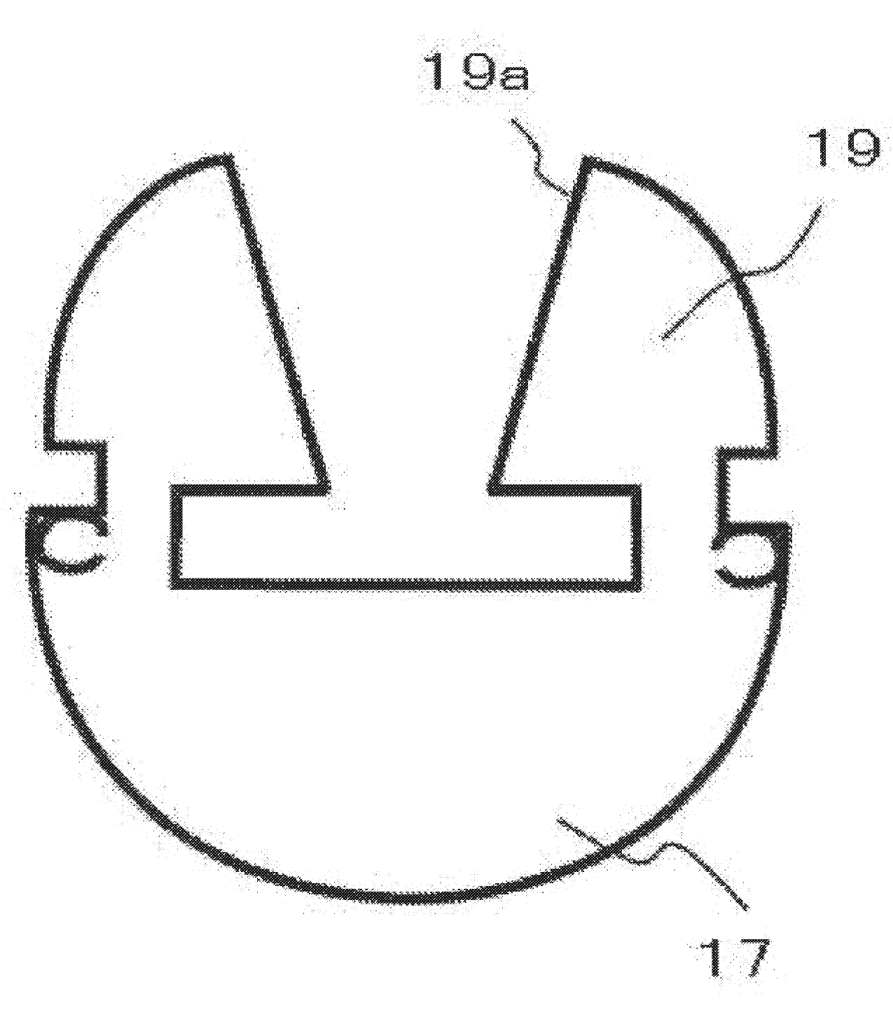

As shown in FIG. 6, when the LED element (light source) X and the measurement points A, B, C is defined, the conventional illumination lamp shown in FIG. 5 and the illumination lamp of the present invention and the fluorescent lamp is obtained the illumination distribution shown in FIG. 6. A comparison of these performance and specifications is shown in FIG. 7. From these results, the superiority of the lighting lamp can be obtained.

The present invention is not limited to the embodiments described above.

Those skilled in the art may make various changes, combinations, or substitutions for the components of the above-described embodiments within the technical scope of the present invention or equivalents thereof.

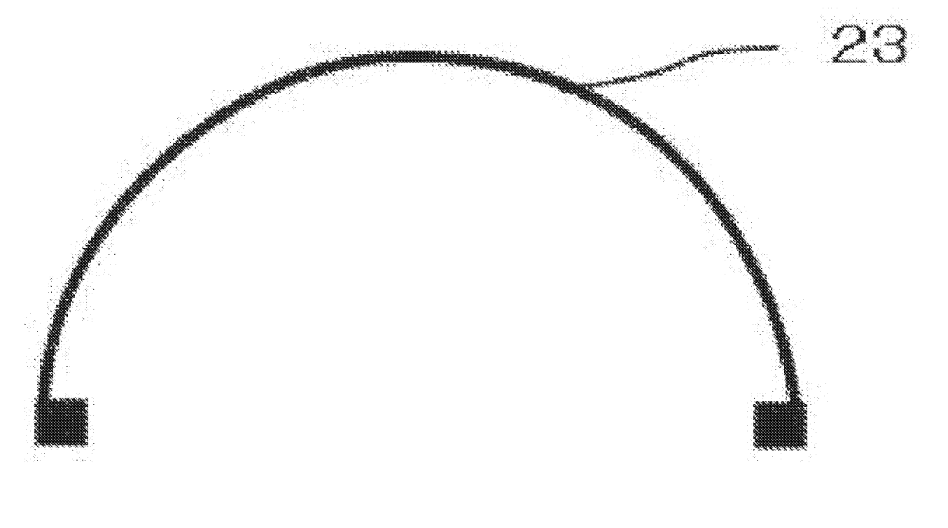

FIG. 8 is a figure for explaining another embodiment of the illumination lamp. The shapes of the first to third heat sinks, the first heat sink material and the second heat sink material of the present invention are not limited to the above-described shapes.

For example, the second heat sink 17 and the third heat sink 19 may be configured as shown in FIG. 8.

The illumination lamp includes a light emitting diode, a translucent cover for transmitting the light from the light emitting diode, a first heat sink which accommodates a light emitting diode integrally formed with the translucent cover, a heat conducting substrate on which a light emitting diode is mounted, a second heat sink for supporting the substrate, and a third heat sink for transferring heat from the second heat sink to the first heat sink in a closed space. The third heat sink extends from the second heat sink toward the translucent cover and one end of the third heat sink is connected to the second and other end is connected to the first heat sink.

Preferably, the surface of light emitting diode in the third heat sink on the straight tube type light emitting diode lamp side has light reflection characteristics. The third heat sink is disposed in a posture directing light from the light emitting diode to the translucent cover.

The third heat sink includes a first heat sink member extending from the second heat sink toward the translucent cover and a second heat sink member extending from the vicinity of an end portion opposite side from second heat sink of the first heat sink member on the opposite side from the second heat sink to face the translucent cover, And a second heat sink member is coupled to the first heat sink.

The surface of the second heat sink member that faces the translucent cover has light reflection characteristics. The A straight tube type light emitting diode lamp is provided with a light emitting diode on the center line of the translucent cover along the cross section of the cylindrical closed space. The third heat sink is line symmetrical with respect to the center line.

1. The A straight tube type light emitting diode lamp comprises
a light emitting diode,
a translucent cover which transmits light from the light emitting diode and has a curved surface protruding in a direction away from the light emitting diode,
a first heat sink formed on the light emitting diode side with respect to the translucent cover so as to accommodate the light emitting diode in a closed space integrally formed with the translucent cover,
a heat conducting substrate provided in the closed space and mounted with the light emitting diode,
a second heat sink provided in the closed space and supporting the substrate,
a third heat sink has a first surface having a light reflecting. characteristic on the light emitting diode side so as to direct the light from the light emitting diode to the translucent cover and transmits heat from the second heat sink to the first heat sink in the closed space,
a third heat sink provided a first surface extending from the second heat sink toward the translucent cover, and
a second heat sink member which is provided at opposite the translucent cover with a gap between the curved surface of the translucent cover, and extends from the vicinity of an end portion on the side opposite second heat sink of the first heat sink member to couple the first heat sink,
wherein the light reflected at the inner surface of the translucent cover in the light from the light emitting diodes is reflected on the second surface having the light reflection characteristic opposite the translucent cover of the second heat sink member and the reflected light is passed through the translucent cover.

2. A straight tube type light emitting diode lamp according to claim 1, wherein the end portion of the first heat sink member is positioned on the translucent cover side it respect to the first heat sink.

3. A straight tube type light emitting diode lamp according to claim 1 or 2, wherein the light emitting diode is located on the center line of the translucent cover along the cross section of the cylindrical closed space, the third heat sink is line symmetrical with respect to the center line.

4. A straight tube type light emitting diode lamp according to 1 to 3, wherein the first face and the second face is performed silver plating, or silver coating.
